(19) United States
(12) Patent Application Publication
(10) Pub. No.: US 2012/0204561 A1
(43) Pub. Date: Aug. 16, 2012

(54) KIT FOR PRODUCING AUTOMOBILES WITH DIFFERENT ENGINE VARIANTS

(75) Inventor: DIRK SCHLÖSSER, Heilbronn (DE)

(73) Assignee: Audi AG, Ingolstadt (DE)

(21) Appl. No.: 13/198,840

(22) Filed: Aug. 5, 2011

(30) Foreign Application Priority Data
Aug. 7, 2010 (DE) 10 2010 033 719.6

(51) Int. Cl. F02B 33/32; F01N 3/021; F01N 3/10; F01N 13/10

(52) U.S. Cl. 60/612; 60/605.1; 60/323; 60/311; 60/299

(57) ABSTRACT

A kit for producing automobiles having different engine variants of auto-ignition internal combustion engines, each engine having two cylinder banks arranged in a V-shape, and components of a turbocharging and/or exhaust gas system is described. All internal combustion engines have mounting elements enabling installation of the components of the turbocharging and/or exhaust gas system in an identical relative position with respect to the internal combustion. Identical or modularized parts can then be used for the turbocharging and/or exhaust gas systems for all engine variants which can be mounted in the same sequential order. Automobiles having different engine variants can thus be manufactured with particularly low inventory and assembly costs.

### CROSS-REFERENCES TO RELATED APPLICATIONS

This application claims the priority of German Patent Application, Serial No. 10 2010 033 719.6, filed Aug. 7, 2010, pursuant to 35 U.S.C. 119(a)-(d), the content of which is incorporated herein by reference in its entirety as if fully set forth herein.

### BACKGROUND OF THE INVENTION

The present invention relates to a kit for producing automobiles with different engine variants.

The following discussion of related art is provided to assist the reader in understanding the advantages of the invention, and is not to be construed as an admission that this related art is prior art to this invention.

Automobiles of a model series are typically offered with different engine variants, which differ in the number of cylinders of the engines, the engine displacement the engine power and the like. Because the different engine variants have different requirements with respect to the installation space, the charge air preparation and the exhaust gas treatment, different components are typically used for the turbocharging and/or exhaust gas system for each engine variant. Depending on the engine design, these components are also mounted engine-specific at different positions in the engine compartment of such automobile. It is therefore necessary to keep a large number of different, model-specific components in inventory. The installation processes for each engine variant are also quite different due to the different mounting positions of the components of the turbocharging and/or exhaust gas system.

It would therefore be desirable and advantageous to obviate prior art shortcomings and to provide an improved kit which facilitates installation of components of a turbocharging and/or exhaust gas system for different engine variants of an automobile and also allows the use of a large number of identical parts for the different engine variants.

### SUMMARY OF THE INVENTION

According to an aspect of the present invention, a kit for producing automobiles with different engine variants of auto-ignition internal combustion engines, each engine having two cylinder banks in V-configuration, includes components of a turbocharging and/or exhaust gas system, and mounting elements arranged on the internal combustion engines for installation the components of the turbocharging and/or exhaust gas system. The mounting elements are arranged on the internal combustion engines so that the components can be installed on the mounting elements of the different engine variants in an identical relative position for all internal combustion engines of the different engine variants.

The mounting elements may include, for example, connection pieces, flanges, threaded openings and the like.

In this way, identical parts can be used for the components of the turbocharging and/or exhaust gas system independent of the engine variant and of the automobile to be produced, saving inventory and development costs. With the engine-independent installation position of the components of the turbocharging and/or exhaust gas system, substantially identical installation sequences and installation processes can be used for all automobile variants that can be produced with the kit, thus simplifying the process flow in the manufacture of the automobile. Due to the variant-independent installation position, substantially the same routing for the charge air lines and exhaust gas lines can be used for all engine variants, which also reduces the number of variants of components to be kept in inventory.

According to an advantageous feature of the present invention, the exhaust manifolds of the internal combustion engines may be arranged on the side of the cylinder banks of the internal combustion engines opposite the respective other cylinder bank. In other words, the exhaust gas manifolds may be located on the inside of the V-arrangement. Arranging the exhaust gas manifolds of the inside of the cylinder banks results in very short exhaust gas paths, resulting in shorter heat-up times of components of the exhaust gas system. These components then reach their optimal operating point more quickly during operation of the automobile, thus reducing the total emissions from the automobile.

According to another advantageous feature of the present invention, the components of the turbocharging and/or exhaust gas system may include a diesel particle filter which can be mounted on a front side of the internal combustion engines. The diesel particle filter is then located in the immediate vicinity of the exhaust gas manifold, allowing a particularly short length of line, so that the operating temperature of the diesel particle filter is reached particularly quickly.

According to another advantageous feature of the present invention, the components of the turbocharging and/or exhaust gas system may include an oxidation catalytic converter which can be mounted on the internal combustion engines—in the installation position of the internal combustion engines—on the top side between the cylinder banks. Very short exhaust gas lines can also be used in this mounting position, because the oxidation catalytic converter is located in the immediate vicinity of the exhaust gas manifold. Because the oxidation catalytic converter operates optimally only at higher temperatures, the operating point of the oxidation catalytic converter is particularly quickly attained with this arrangement, thereby reducing emissions, as described above.

According to another advantageous feature of the present invention, the components of the turbocharging and/or exhaust gas system may include a first exhaust gas turbocharger which can be mounted—in the installation position of the internal combustion engines—on associated mounting elements of the internal combustion engines located on a top side between the cylinder banks. The turbocharger is thereby placed, on one hand, in the immediate vicinity of the exhaust gas manifold, so that the exhaust gas path from the manifold to the turbine side of the exhaust gas turbocharger is particularly short. On the other hand, an exhaust gas turbocharger may optionally also be in the immediate vicinity of the oxidation catalytic converter which is connected to the gas outlet of the turbine side of the turbocharger. This also reduces the required length of the line.

According to another advantageous feature of the present invention, the components of the turbocharging and/or exhaust gas system may include an additional exhaust gas turbocharger which can also be mounted on the internal combustion engines—in the installation position of the internal combustion engine—on a top side between the cylinder banks. The second exhaust gas turbocharger may be combined with the first exhaust gas turbocharger in a conventional manner in form of a bi-turbo arrangement. The aforedescribed advantages for the first exhaust gas turbocharger then also apply to the second exhaust gas turbocharger.

According to another advantageous feature of the present invention the second exhaust gas turbocharger may be connected in series with the first exhaust gas turbocharger. At low engine RPM end hence lower charge air demand, only the first turbocharger is used. When the RPM and the charge air demand increase, the second turbocharger is added. Such sequential arrangement has a positive effect on the emissions, because the surface area of the parts to be heated is smaller when operating with only one turbocharger than when operating with two turbochargers. The response at low RPM is also improved, because the single turbine has a smaller mass inertia than two turbines. The required charge pressure can then be built up more quickly.

According to another advantageous feature of the present invention, the components of the turbocharging and/or exhaust gas system may include an air filter which may be mounted on an outside of a cylinder bank of the internal combustion engines. The air filter may then be arranged on the side of the cylinder bank opposite the exhaust gas manifold, i.e., in close proximity to the intake valves, resulting in a particularly short line routing.

According to another advantageous feature of the present invention, the aforedescribed kit may be used with internal combustion engines having six cylinders or eight cylinders; however, the kit may also be used with internal combustion engines having a greater number of cylinders, such as V10 and V12 engines.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 a schematic diagram of the arrangement of components on a six-cylinder V-type internal combustion engine with simple turbocharging according to the state-of-the-art;

FIG. 2 a schematic diagram of the arrangement of components on a six-cylinder V-type internal combustion engine with bi-turbocharging according to the state-of-the-art;

FIG. 3 a schematic diagram of the arrangement of components on an eight-cylinder V-type internal combustion engine with bi-turbocharging according to the state-of-the-art;

FIG. 4 a schematic diagram of the arrangement of components of a six-cylinder V-type internal combustion engine with simple turbocharging that can be produced with an exemplary embodiment of a kit according to the present invention;

FIG. 5 a schematic diagram of the arrangement of components of a six-cylinder V-type internal combustion engine with bi-turbocharging that can be produced with an exemplary embodiment of a kit according to the present invention; and

FIG. 6 a schematic diagram of the arrangement of components of an eight-cylinder V-type internal combustion engine with bi-turbocharging that can be produced with an exemplary embodiment of a kit according to the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

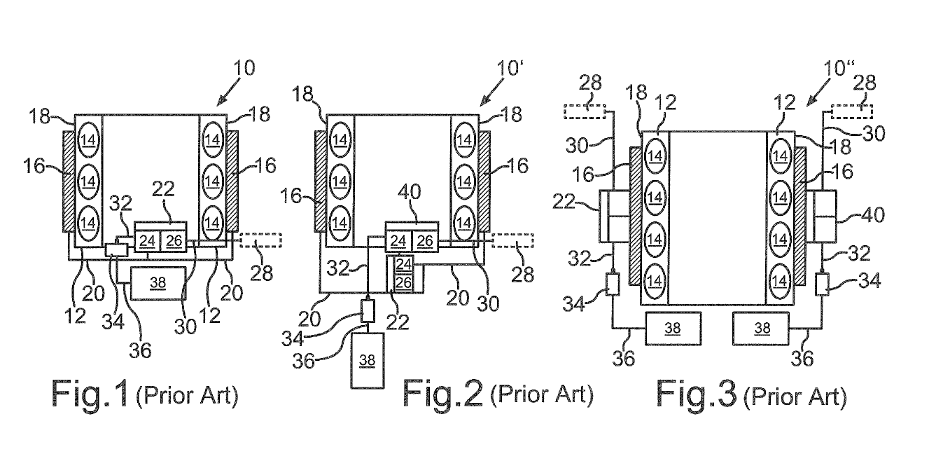

Turning now to the drawing, and in particular to FIG. 1, there is shown a conventional internal combustion engine having the overall reference symbol 10 representing a six-cylinder V-type diesel engine. The internal combustion engine 10 has two cylinder banks 12, each having three cylinders 14, which are inclined with respect to one another in a V-shape and drive a common crankshaft. The exhaust gas manifolds 16 of the cylinders 14 are arranged on the outsides 18 of the cylinder banks 12. Exhaust gas lines 20 are routed from the exhaust gas manifolds 16 to an exhaust gas turbocharger 22, where the hot exhaust gas enters the turbocharger 22 on the turbine side 24, driving the turbine of the turbocharger. The turbine drives a compressor impeller arranged on the compressor side 26 of the turbocharger 22, which suctions in ambient air through an air filter 28 via a line 30 and supplies the air to the cylinders 14 through unillustrated lines. The exhaust gas exiting on the turbine side 24 of the turbocharger 22 is routed via a line 32 into an oxidation catalytic converter 34, where uncombusted hydrocarbons and carbon monoxide in the exhaust gas are oxidized to carbon dioxide.

The exhaust gas is routed via another line 36 from the oxidation catalytic converters 34 to a diesel particle filter 38 where soot particles are filtered out. Due to the relatively large distance from the turbocharger 22 and oxidation catalytic converter 34 to the exhaust gas manifolds, the exhaust gas can cool down in the lines 20 which reduces the efficiency of the turbocharger 22 and also causes longer heat-up times of the oxidation catalytic converter.

FIG. 2 also shows a conventional internal combustion engine 10′ designed as a six-cylinder V-type engine. This engine differs from the internal combustion engine illustrated in FIG. 1 by bi-turbocharging with two turbochargers 22, 40. Like in the embodiment of FIG. 1, the hot exhaust gas is routed from the exhaust gas manifolds 16 via lines 20 to the turbine side 24 of the first turbocharger 22. The exhaust gas exiting from the turbine of the first turbocharger 22 then enters the turbine side 24 of the second turbocharger 40, with the exhaust gas now driving the compressor impellers of both turbochargers. The charge air is hereby suctioned in on the compressor side 26 of the second turbocharger 40 through a line 30 and an air filter 28, and the pre-compressed air is then supplied to the compressor of the first turbocharger 22. The charge air exiting from the compressor side 26 of the two turbochargers 22, 40 is, if necessary, cooled by a charge air cooler and supplied to the cylinders 14. The exhaust gas exiting the turbine side of the second exhaust gas turbocharger 40 is also supplied to an oxidation catalytic converters 34 through a line 32 and flows from the oxidation catalytic converter 34 through a line 36 into a diesel particle filter 38 and from there through an unillustrated muffler into the environment. The routes from the exhaust gas manifolds 16 to the turbochargers 22 and 40 are here also long, which may cause significant cool-down of the exhaust gas. Moreover, the illustrated arrangement results in a particularly conduit path between the second turbocharger 40 and the oxidation catalytic converter 34, causing particularly long heat-up times of the oxidation catalytic converter 34, which results in increased emissions at least in a startup phase of the internal combustion engine 10′.

FIG. 3 illustrates another internal combustion engine 10″ implemented as an eight-cylinder V-type diesel engine. The cylinder banks 12 each have four cylinders 14 which also inclined with respect to one another in a V-shape. The exhaust gas manifolds 16 are also located on the outsides 18 of the cylinder banks 12. This internal combustion engine 10″ also has a bi-turbocharger arrangement. Unlike in the internal combustion engine 10′, the two turbochargers 22, 40 are here not connected in series. Instead, each turbocharger 22, 40 is associated with a cylinder bank 12 and arranged on its outside 18 in close proximity to the exhaust gas manifolds 16. The exhaust gas enters the turbine side 24 of the turbocharger 22 directly from the exhaust gas manifolds 16, 40 and drives the compressor impeller of the compressor side 26 of the turbocharger 22, 40. Each turbocharger 22, 40 has its own air filter 28, via which ambient air is suctioned in through a line 30 and supplied to the compressor of the turbocharger 22, 40. From there, the air then optionally flows to the cylinders 14 through an unillustrated charge air cooler. The air exiting on the turbine side 24 of the turbocharger 22, 40 is herein also routed to oxidation catalytic converters 34 through lines 32, where carbon monoxide and unburned hydrocarbons are oxidized. The catalytically cleaned exhaust gas is routed from the oxidation catalytic converters 34 through additional lines 36 to diesel particle filters 38 and discharged therefrom into the environment. Both the oxidation catalytic converters 34 and the diesel particle filters 38 are present in duplicate, wherein each oxidation catalytic converter 34 and each diesel particle filter 38 supply a corresponding cylinder bank 12.

The overall arrangement of the components of the turbocharging and/or exhaust gas system for the three illustrated conventional engines 10, 10′ and 10″ differ significantly. Therefore, dedicated components must be kept in inventory for each of these engine variants. Each of the internal combustion engines 10, 10′, 10″ also requires a dedicated installation sequence due to the different mounting position of the illustrated components. This significantly increases the production costs of automobiles with these engine variants.

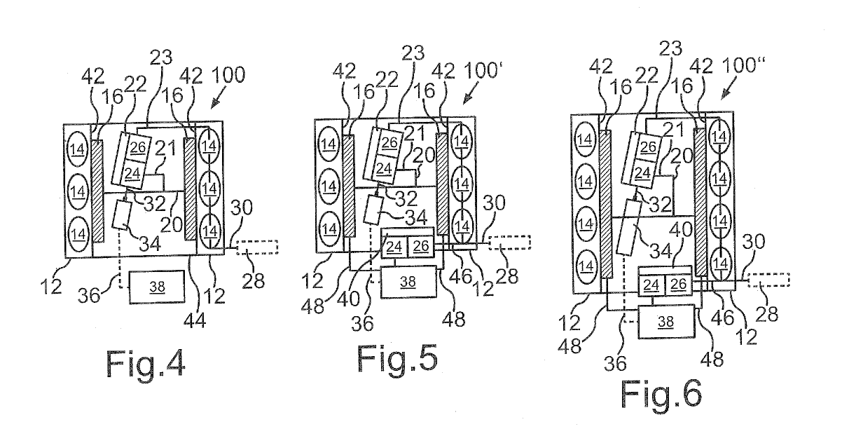

It would therefore be advantageous to use a kit for producing automobiles with different engine variants in order to reduce the costs associated with providing the components, logistics and manufacture. FIGS. 4 to 6 show three different internal combustion engines with associated components of a turbocharging and/or exhaust gas system that can be produced with a kit according to the present invention.

The internal combustion engine 100 of FIG. 4, like the internal combustion engine 10 of FIG. 1, is designed as a six-cylinder V-type internal combustion engine. The internal combustion engine 100 also has two cylinder banks 12, each having three cylinders 14. In contrast to the internal combustion engine 10, the exhaust gas manifolds 16 are here arranged on the insides 42 of the cylinder banks 12. The exhaust gas turbocharger 22 is located between the cylinder banks 12 and is connected with a connecting piece 21 to a line 20. Because the exhaust manifold 16 is located on the inside, only a very short line 20 is required for supplying exhaust gas to the turbine side 24 of the exhaust gas turbocharger 22. The exhaust gas exiting from the turbine side of the exhaust gas turbocharger 22 is routed through a likewise short exhaust gas line 32 to the oxidation catalytic converter 34 which is mounted with unillustrated mounting elements on the top side of the internal combustion engine in its installed position. The exhaust gas therefore has still a very high temperature both in the turbocharger 22 and in the oxidation catalytic converter 34, so that the exhaust gas turbocharger 22 generates very high power and the oxidation catalytic converters 34 reaches its operating temperature particularly fast.

The diesel particle filter 38 is connected with the oxidation catalytic converter 34 via a line 36 and connected on a front face 44 of the internal combustion engine 100 by way of likewise unillustrated mounting elements. Air is here also supplied to the compressor side 26 of the exhaust gas turbocharger 22 via an air filter 28 and an associated line 30. The line 30 is connected to the exhaust gas turbocharger 22 via a connecting piece 23. Overall, particularly short conduits, a high turbocharger power and rapid heating of the oxidation catalytic converter 34 are attained in this manner. This improves the efficiency of the automobile and reduces its emissions.

The internal combustion engine 100′ according to FIG. 5 is also implemented as a six-cylinder V-type internal combustion engine. It differs from the internal combustion engine 100′ by a sequentially arranged bi-turbocharger arrangement. A first exhaust gas turbocharger 22 is mounted in the same mounting position as the exhaust gas turbocharger 22 in the internal combustion engine 100. The installation positions of the oxidation catalytic converter 34 and of the diesel particle filter 38 are also identical. This is made possible by the identical position of the connecting pieces 21, 23 and the unillustrated mounting elements. The internal combustion engine 100′ has an additional exhaust gas turbocharger 40 which is also arranged on the top side of the internal combustion engine 100′ between the cylinder banks 12. The exhaust gas turbocharger 22 is used when the automobile is operated at low RPM and receives, similar to the internal combustion engine of FIG. 4, exhaust gas on the turbine side 24 through the line 20. The compressor impeller of the exhaust gas turbocharger 22 then suctions in air through the air filter 28 and the line 30 and delivers the air to the cylinders 14.

The exhaust gas flows from the exhaust gas side 24 of the exhaust gas turbocharger in a conventional manner through the oxidation catalytic converter 34 and the diesel particle filter 38. At higher engine RPM, the second exhaust gas turbocharger 40 is switched in and receives charge air from the air filter 28 through the line 46. The turbine side 24 of the second exhaust gas turbocharger 40 is in this operating mode supplied with exhaust gas from the exhaust gas manifolds 16 through an additional exhaust gas line 48, thereby driving the turbine.

FIG. 6 lastly shows another internal combustion engine 100″ constructed as an eight-cylinder V-type internal combustion engine. The basic construction of the internal combustion engine 100″ herein corresponds to that of the internal combustion engine 10″ of FIG. 3. Like the internal combustion engines 100 and 100′, the internal combustion engine 100″ also has exhaust gas manifolds 16 arranged on the insides 42 of the cylinder banks 12. In all other aspects, the arrangement of the additional components of the turbocharging and/or exhaust gas system corresponds to that of the internal combustion engine 100′ according to FIG. 5—representing a bi-turbocharger arrangement composed of the two sequentially arranged turbochargers 22 and 40.

Identical turbochargers 22, oxidation catalytic converters 34 of modular construction, diesel particle filters 38 of modular construction and identical air filters 28 can be used for all internal combustion engines 100, 100′ and 100″. The oxidation catalytic converters 34 and the diesel particle filters 38 for the different internal combustion engines 100, 100′ and 100″ have preferably the same diameter, but may have different lengths commensurate with the required maximum exhaust gas throughput. The turbocharger 40 may also be identical for all internal combustion engines 100, 100′ and 100″ or may be adapted to the respective engine power depending on the engine variant. All internal combustion engines 100, 100′ and 100″ have identically positioned mounting elements and connecting pieces 21, 23 for the exhaust gas turbochargers 22, 40, oxidation catalytic converters 34, diesel particle filters 38 and air filters 28. The mounting positions of the respective parts are therefore identical for all illustrated internal combustion engines 100, 100′ and 100″, so that the same manufacturing processes can be used. Overall, the inventory and installation costs in the manufacture of automobiles having different engine variants can be significantly reduced by using the aforedescribed kit.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A kit for producing automobiles with different engine variants of auto-ignition internal combustion engines, each engine having two cylinder banks in V-configuration, the kit comprising:
components of a turbocharging and/or exhaust gas system, and
mounting elements arranged on the internal combustion engines for installation the components of the turbocharging and/or exhaust gas system, said mounting elements arranged on the internal combustion engines so that the components can be installed on the mounting elements of the different engine variants in an identical relative position for all internal combustion engines of the different engine variants.

2. The kit of claim 1, further comprising exhaust manifolds arranged on opposing sides of the two cylinder banks.

3. The kit of claim 1, wherein the components of the turbocharging and/or exhaust gas system comprise a diesel particle filter constructed for installation on mounting elements disposed on a front face of the internal combustion engines.

4. The kit of claim 1, wherein the components of the turbocharging and/or exhaust gas system comprise an oxidation catalytic converter constructed for installation on mounting elements disposed on a top side between the two cylinder banks, in an installation position of the internal combustion engines.

5. The kit of claim 1, wherein the components of the turbocharging and/or exhaust gas system comprise a first exhaust gas turbocharger constructed for installation on mounting elements disposed on a top side between the two cylinder banks, in an installation position of the internal combustion engines.

6. The kit of claim 5, wherein the components of the turbocharging and/or exhaust gas system comprise a second exhaust gas turbocharger constructed for installation on mounting elements disposed on a top side between the two cylinder banks, in an installation position of the internal combustion engines.

7. The kit of claim 6, wherein the second exhaust gas turbocharger is configured for sequential connection to first exhaust gas turbocharger.

8. The kit of claim 1, wherein the components of the turbocharging and/or exhaust gas system comprise an air filter constructed for installation on mounting elements disposed on an outside of a cylinder bank.

9. The kit of claim 1, wherein the different engine variants of auto-ignition internal combustion engines include at least one internal combustion engine with six cylinders and at least one internal combustion engine with eight cylinders.
